(19) United States
(12) Patent Application Publication
(10) Pub. No.: US 2019/0127047 A1
(43) Pub. Date: May 2, 2019

(54) CARRIAGE FOR SUPPORTING AND GUIDING A FLAP AND AIRFOIL FLAP SYSTEM FOR USE IN AN AIRCRAFT

(71) Applicant: Airbus Operations GmbH, Hamburg (DE)

(72) Inventor: Rainer Gartelmann, Hamburg (DE)

(21) Appl. No.: 16/159,885

(22) Filed: Oct. 15, 2018

(30) Foreign Application Priority Data
Oct. 30, 2017 (DE) 10 2017 125 381.5

(51) Int. Cl. B64C 13/28; B64C 9/02; B64C 9/14; F16C 17/02; F16C 33/20

(52) U.S. Cl. CPC B64C 13/28; B64C 9/02; F16C 33/201; F16C 17/02; B64C 9/14

(57) ABSTRACT

A carriage for supporting and guiding an aircraft flap translationally moveable along a linear slide bearing comprises a drive element connectable to an actuator for receiving a translational actuating force causing a translation of the carriage along the slide bearing. A flap support of the carriage is configured to, upon translational movement of the carriage, transmit the actuating force to the flap. The carriage further has a slide plate with at least two slide elements arranged on opposed sides of the slide plate which are engageable to at least two corresponding linear slide rails of the slide bearing.

### CROSS-REFERENCES TO RELATED APPLICATIONS

This application claims the benefit of the German patent application No. 10 2017 125 381.5 filed on Oct. 30, 2017, the entire disclosures of which are incorporated herein by way of reference.

### BACKGROUND OF THE INVENTION

The present invention refers to a carriage for supporting and guiding an aircraft flap and to an aircraft flap system equipped with a carriage of such type.

Aircraft airfoils are designed such that their geometry of the airfoil profile is adjustable or adaptable to the varying boundary conditions prevailing in different states of the course of a flight, such as during landing, take-off or cruise. Flap arrangements are known for selectively actuating a flap connected to an airfoil main body to extend into or retract from an air flow boundary layer of the airfoil so as to selectively vary the aerodynamic lift generated by the airfoil. Such conventionally known flap arrangements have a complex construction requiring a complex support and drive mechanism for selectively extending and retracting the flap arrangement. For reducing the complexity of such flap arrangements, it is further known to provide a linear rolling bearing in the airfoil main body for supporting and guiding the flap so as to, upon translationally moving a carriage supporting the flap along the linear rolling bearing, extend or retract the flap.

### SUMMARY OF THE INVENTION

The invention is directed at an object of providing a carriage for supporting and guiding an aircraft flap that has a simple and load-optimized design improving the cost-efficiency and reliability of an airfoil flap system. The invention is further directed at an object of providing an airfoil flap system for use in an aircraft that is equipped with a carriage of such type.

A carriage for supporting and guiding an aircraft flap is provided. The flap supported and guided by the carriage preferably forms a part of an aerodynamic component of an aircraft, such as an airfoil, a wing, an aileron, a rudder, an elevator or the like. The flap further is preferably connected to a main body of the aerodynamic component and is configured to, upon being actuated, move between an extended and retracted position. Specifically, the carriage is translationally moveable along a linear slide bearing. The linear slide bearing is preferably designed to provide free motion of the carriage along only one axis. The carriage is preferably configured to, upon being translationally moved along the linear slide bearing, actuate the flap so as to move the flap between its extended and retracted position.

For actuating the flap, the carriage comprises a drive element connectable to an actuator for receiving a translational actuating force causing a translation of the carriage along the slide bearing. The drive element may be a screw nut which, together with a threaded shaft connectable to the screw nut, forms a linear actuator that is configured to translate rotational motion of the threaded shaft to linear motion of the carriage. Specifically, the linear actuator formed by the drive element may be a ball screw drive. In such a configuration, a ball nut formed by the drive element and a ball screw may be packaged in an assembly with recirculating ball bearings which roll in matching ball forms provided between the ball nut and ball screw. The forces transmitted are preferably distributed over a large number of ball bearings, giving a low relative load per ball and a very low friction coefficient. Alternatively, the linear actuator may be a worm gear.

Further, the carriage has a flap support configured to, upon translational movement of the carriage, transmit the actuating force to the flap. In other words, the flap support is connectable to the flap in a force transmitting manner. The flap support may be rotatably connected to the flap. Specifically, the flap support may have a rotatory joint connectable to the flap, in particular to a connecting element of the flap. The rotatory joint may have a rotation axis transverse to the direction of movement of the carriage along the linear slide bearing. Further, the flap support may have a U-shaped cross section with two spaced, separate connecting arms for receiving the rotary joint and the connecting element of the flap connectable to the rotary joint. For receiving the rotary joint, the flap support may comprise a through-hole extending through the connecting arms, i.e., in parallel to the rotation axis of the rotary joint. By providing the flap support with the U-shaped cross-section, in a state in which the flap is connected to the carriage, a free rotational movement of the connecting element around the rotary joint can be ensured.

Still further, the carriage comprises a slide plate with at least two slide elements arranged on opposed sides of the slide plate and engageable to at least two corresponding linear slide rails of the slide bearing.

Thus, a carriage is provided that is configured to be supported and guided along a linear slide bearing, also referred to as a linear plain bearing. Compared to known flap arrangements having a rolling-element bearing, such as ball bearings or roller bearings, for supporting and guiding a carriage of a flap, the use of a slide bearing has the effect that rolling-elements can be omitted. Accordingly, the number of movable parts and thus the number of parts subjected to wear can be reduced. Further, rolling-element bearings cause point loads between the rolling elements and a guiding rail or track. Upon moving the carriage, this can cause alternating and dynamic loads on local contact points inducing a risk of damaging to rail and roller. By providing a slide bearing, a contact surface between the slide elements and the slide rails is enlarged compared to rolling-element bearings, thereby providing a load-optimized design avoiding local contact points. Still further, the sliding couples of the slide bearing formed by the slide elements and the slide rails are preferably self-lubricating. As a result, a less complex and light-weight design of the carriage can be ensured that is also cost-efficient with respect to its manufacturing as well as its maintenance. With reducing the number of parts subjected to wear, also the reliability of a flap actuating system equipped with a carriage of such type can be improved.

Furthermore, in addition to supporting and guiding the flap, the carriage is configured to receive and transmit the actuating force to the flap so as to move it between its exposed and retracted position. In other words, compared to conventional flap arrangements, the functionality of both supporting and actuating the flap is allocated to the carriage. In this way, actuating elements provided separately from the carriage can be omitted, thereby further reducing the number of movable parts.

The slide plate may be designed to receive the drive element and the flap support. In other words, the drive element and the flap support may be connected to the slide plate in a force transmitting manner. For example, each of the drive element and the flap support may be directly fixed to the slide plate. The drive element and the flap support may have a shape that is adapted to the slide plate. The slide plate may be provided in form of a planar plate. Alternatively, the slide plate may be at least partially provided in form of a curved plate. The slide plate may have a first large surface and a second large surface opposed to the first large surface. Preferably, the drive element and the flap supported are mounted on opposed surfaces of the slide plate, i.e., on the first large surface and the second large surface. For example, the drive element may be mounted on the first large surface and the flap support may be mounted on the second large surface of the slide plate.

Further, the slide elements of the slide plate may extend along opposing edge regions of the slide plate. In other words, a first slide element may be arranged in a region of a first edge of the slide plate and a second slide element may be arranged in a region of a second edge of the slide plate that is arranged opposed to the first edge. Specifically, the drive element and the flap support may be designed and mounted on the slide plate such that opposing edge regions of the slide plate protrude beyond the drive element and the flap support in opposing directions along a longitudinal and/or transversal axis of the slide plate. These opposing edge regions may form or accommodate the first and the second slide element. Preferably, in such a configuration, the slide elements formed by the opposing edge regions of the slide plate extend along the longitudinal axis thereof. In this context, a longitudinal axis of the slide plate is referred to an extension thereof that is greater than its extension along a direction transverse thereto, i.e., along the transversal axis. By this configuration, a sliding surface of the slide elements, i.e., the contact surface between the slide elements and the slide rails, can be an enlarged relative to the surface of the slide plate.

Specifically, the slide elements are designed and configured to engage with one of the at least two corresponding linear slide rails of the slide bearing. Accordingly, each of the at least two slide elements, e.g., in its dimensions and shape, may be adapted to one of the at least two corresponding linear slide rails of the slide bearing. Each of the slide elements may have an outer contour that is adapted to an outer contour of one of the linear slide rails of the slide bearing, respectively. For example, the linear slide rails of the slide bearing may have a U-shaped cross section having two legs, wherein the slide elements are configured to be arranged therebetween. Alternatively, the slide elements may have a U-shaped cross section having two legs, wherein the slide rails are configured to be arranged therebetween.

In a further development, for improving the reliability and robustness of the carriage, the slide plate may be provided with crack stoppers. In general, a crack stopper is designed to avoid that, once a crack or rupture is present in the slide plate or the slide elements, the crack or rupture propagates or spreads within the component causing a failure of the carriage. Cracks or ruptures within the slide plate may particularly occur by virtue of material defects of the slide plate. Thus, for improving the robustness of the carriage, the slide element may be provided with at least one crack stopper aperture which is formed in a thickness direction of the slide plate and extends from an edge of the slide plate, i.e., accommodating or forming one of the at least two slide elements, in direction of a central longitudinal axis of the slide plate beyond one of the slide elements. Preferably, in an area of each of the at least two slide elements, at least one crack stopper aperture is provided within the slide plate.

The slide elements may be formed by a surface of the opposing edge regions of the slide plate. Alternatively or in addition, the slide elements at least partially may be provided in form of attachments detachably connected to the opposing edge regions of the slide plate. Specifically, the attachments may have an outer contour adapted to a shape of the linear slide rails of the slide bearing and an inner contour adapted to a contour of the edge regions or edges of the slide plate. Further, to ensure an even force transmission between the slide plate and the attachments, the edge regions of the slide plate engaging with the attachments may be at least partially rounded. In this way, the slide plate can be prevented from being subjected to local point loads. By providing the attachments forming the slide elements, components of the slide bearing subjected to wear can be easily adapted and replaced, thereby providing an improved configurability and maintenance of the carriage.

In a further development, the attachments may be provided with a first locking element configured to engage with a complementary formed second locking element provided by the slide plate. In this configuration, the first and the second locking element may be configured to lock a relative movement between the attachments and the slide plate in the movement direction of the carriage and, in particular, in a direction transverse to the movement direction. Specifically, the first and the second locking element may be configured to further lock a relative movement between the attachments and the slide plate in a direction parallel to the transverse axis of the slide plate.

Further, the sliding surface of the slide elements, i.e., the contact surface between the slide elements and the slide rails, may be provided with a self-lubricating coating. Specifically, the self-lubricating coating may contain Teflon (polytetrafluorethylene). Additionally or alternatively, the slide rails may be made of steel and preferably are provided with a DLC (Diamond Like Carbon) coating. In this way, measures, such as a lubrication unit or maintenance services, for ensuring that a sufficient lubrication film is provided on the sliding surface can be dispensed with, thereby simplifying the maintenance of the carriage and ensuring a simple design thereof.

Further, an airfoil flap system for use in an aircraft is provided, having a flap that is movable between an extended and retracted position, a carriage for supporting and guiding the flap having the above mentioned technical features and an actuator connected to the carriage for generating an actuating force causing a translation of the carriage along the linear slide bearing so as to move the flap between its extended and retracted position.

### BRIEF DESCRIPTION OF THE DRAWINGS

Preferred embodiments of the invention are explained in greater detail below with reference to the accompanying schematic drawings, in which:

FIG. 1 shows a state of the art airfoil flap system,

FIG. 2 shows a front view of a carriage for supporting and guiding an aircraft flap according to a first embodiment,

FIG. 3 shows a top view of a slide plate comprised in the carriage shown in FIG. 2.

FIG. 4 shows a front view of a carriage for supporting and guiding an aircraft flap according to a second embodiment,

FIG. 5 shows a top view of a slide plate comprised in the carriage shown in FIG. 4,

FIG. 6 shows a cross section view along section A-A indicated in FIG. 5, and

FIG. 7 shows a cross section view along section B-B indicated in FIG. 5.

### DETAILED DESCRIPTION OF THE PREFERRED EMBODIMENTS

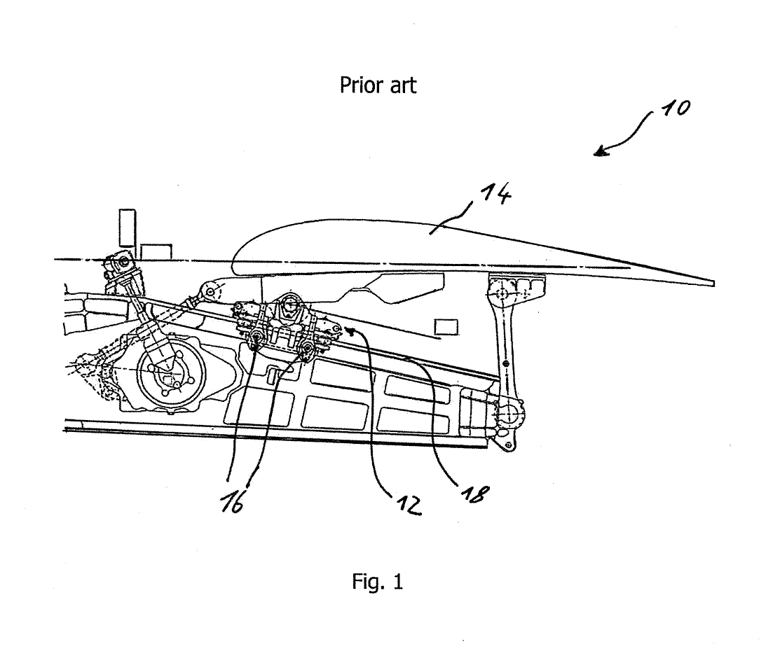

FIG. 1 shows a conventionally known airfoil flap system 10 having a carriage 12 for supporting and guiding a flap 14 that is movable between an extended and retracted position. The carriage 12 has rolling-elements 16 that are engaged with linear slide rails 18 and form a linear rolling-element bearing. By this configuration, the carriage 12 is translationally movable along the linear slide rails 18 when the flap 14 is actuated by an actuating device connected to a structure of the flap so as to move between its extended and retracted position.

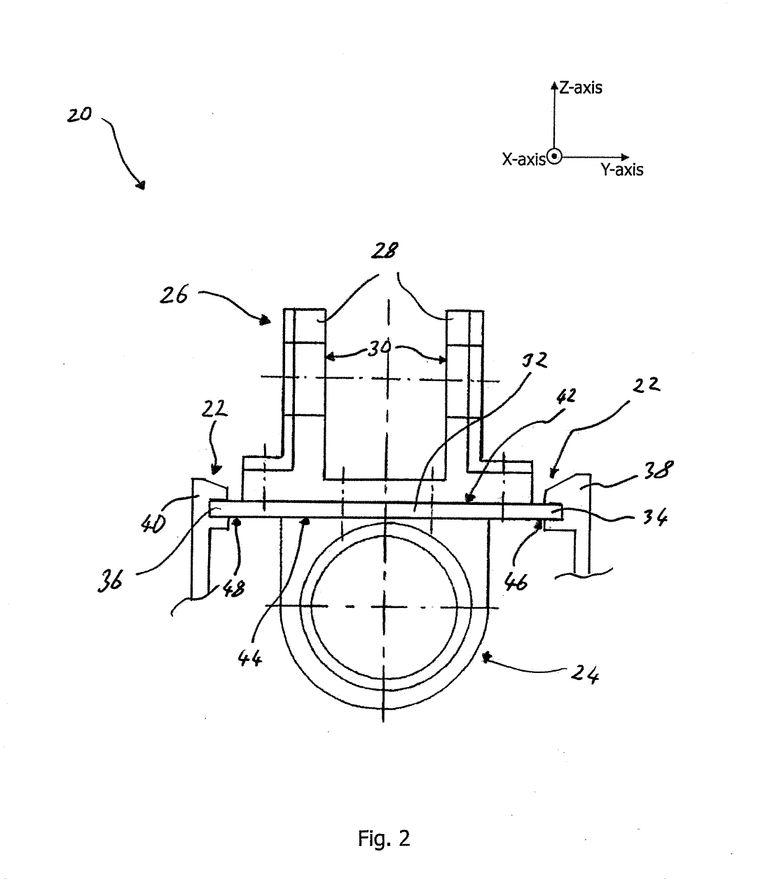

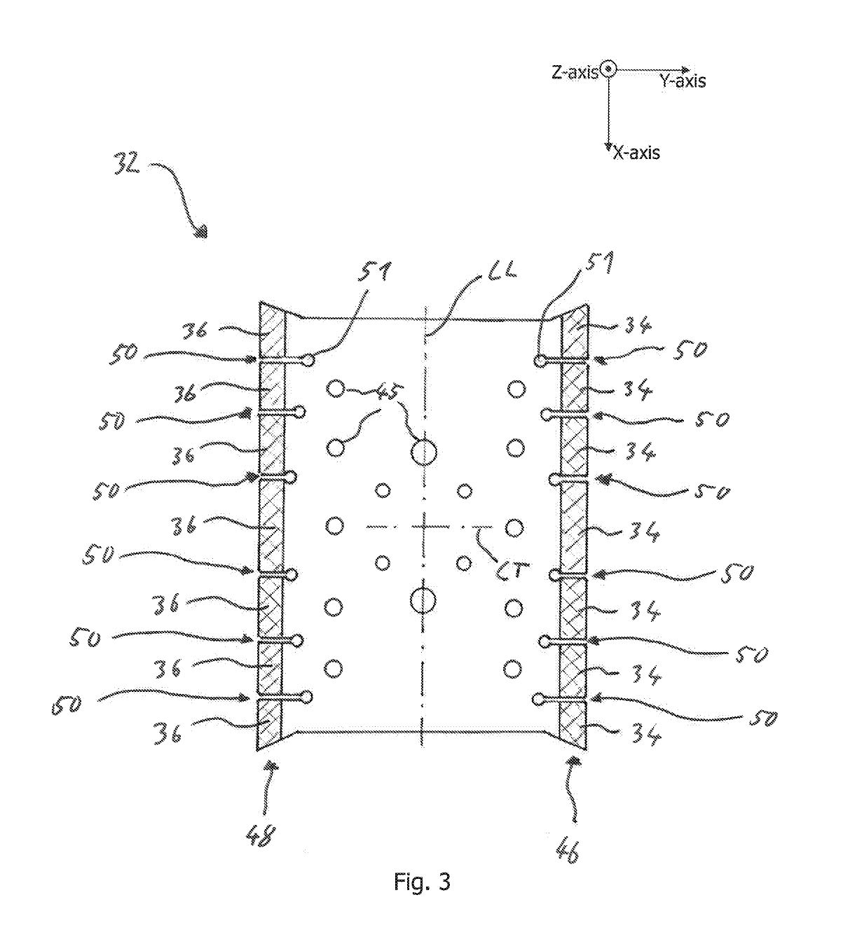

FIGS. 2 and 3 show a carriage 20 for supporting and guiding an aircraft flap according to a first embodiment. The flap supported and guided by the carriage 20 forms a part of an airfoil, such as a wing of the aircraft, and is connected to a main body of the airfoil. The carriage 20 is translationally moveable along a linear slide bearing 22. The linear slide bearing 22 is designed to provide free motion of the carriage 20 along one axis. Specifically, in the shown embodiment, a free motion of the carriage 20 along an X-axis normal to an image plane of FIG. 2 is provided. Further, the carriage 20 is configured to, upon being translationally moved along the linear slide bearing 22, actuate the flap so as to move the flap between an extended and retracted position. For actuating the flap, the carriage 20 comprises a drive element 24 connectable to an actuator for receiving a translational actuating force causing a translation of the carriage 20 along the slide bearing 22 in a direction along the X-axis. The drive element 24 is provided in form of a screw nut which, together with a threaded shaft connectable to the screw nut, forms a linear actuator that is configured to translate rotational motion of the threaded shaft to linear motion of the carriage 20. Specifically, the linear actuator formed by the drive element 24 is a ball screw drive.

Further, the carriage 20 has a flap support 26 configured to, upon translational movement of the carriage 20, transmit the actuating force received by the drive element 24 from the actuator to the flap. The flap support 26 is rotatably connected to the flap. Specifically, the flap support 26 has a rotatory joint, which is not shown in FIG. 2, connectable to a connecting element of the flap. The rotatory joint has a rotation axis parallel to a Y-axis which is transverse to the direction of movement of the carriage along the X-axis. The flap support 26 has a U-shaped cross section with two spaced, separate connecting arms 28 for receiving the rotary joint and the connecting element of the flap connected to the rotary joint. Specifically, for receiving the rotary joint, the flap support comprises a through-hole 30 extending through the connecting arms 28 in parallel to the rotation axis of the rotary joint, i.e., the Y-axis. Thus, in a state in which the flap support 26 is connected to the flap, a free rotational movement of the connecting element arranged between the connecting arms 28 for moving the flap between its extended and retracted position can be ensured.

The carriage 20 further comprises a slide plate 32 having two slide elements, a first slide element 34 and a second slide element 36, arranged on opposed sides of the slide plate 32 and engageable with two corresponding linear slide rails 38, 40 of the slide bearing 22, respectively. In this way, the two slide elements 34, 36, together with the two corresponding linear slide rails 38, 40, form the slide bearing 22.

The slide plate 32 is provided in form of a planar plate having a first large surface 42 and a second large surface 44 opposed to the first large surface 42. The support element 26 is mounted on the first large surface 42 and the drive element 24 is mounted on the second large surface 44. Thus, the drive element 24 and the flap support 26 are mounted on the opposed surfaces 42, 44 of the slide plate 32. This is achieved by virtue of connecting means protruding through the slide plate 32 and connecting the slide plate 32, the drive element 24 and the flap support 26 together in a force transmitting manner. Specifically, as shown in FIG. 3, the slide plate 32 is provided with a plurality of through-holes 45 extending in a thickness direction of the slide plate 32 through which the connecting means are guided.

The first and the second slide element 34, 36 extend along opposing edge regions 46, 48 of the slide plate 32. Specifically, the first slide element 34 is arranged in a region of a first edge 46 of the slide plate 32 and the second slide element 36 is arranged in a region of a second edge 48 of the slide plate 32 that is arranged opposed to the first edge region 46. The first slide element 34 and the second slide element 36 extend along a longitudinal axis of the slide plate 22 that is in parallel to the X-axis. Further, the drive element 24 and the flap support 26 are designed and mounted on the slide plate 32 such that the opposing edge regions 46, 48 of the slide plate 32 protrude or extend along a transverse axis of the slide plate beyond the drive element 24 and the flap support 26. In the shown configuration, the transverse axis of the slide plate 32 is parallel to the Y-axis.

The first and the second slide elements 34, 36 are designed and configured to engage with the first and the second linear slide rails 38, 40, respectively. Accordingly, each of the first and the second slide elements 34, 36 has an outer contour that is adapted to an outer contour of one of the linear slide rails 38, 40, respectively. Specifically, each of the first and the second the linear slide rails 38, 40 has a U-shaped cross section, in which one of the first and the second slide elements 34, 36 is received.

For improving the reliability and robustness of the carriage 20, as shown in FIG. 3, the slide plate 32 is provided with a plurality of crack stopper apertures 50. The crack stopper apertures 50 are formed in the thickness direction of the slide plate 32 and, in an area of each of the first and the second slide element 36, 38, extend from an edge of the slide plate 32 in direction of a central longitudinal axis CL of the slide plate 32 beyond the first or second slide element 36, 38, in the area of which the crack stopper aperture 50 is provided. By providing the crack stopper apertures 50, the first and the second slide element 34, 36 are separated into sections. The dimensions of the crack stopper apertures 50 vary in dependence on their respective locations within the slide plate 32. Specifically, the closer a crack stopper aperture 50 is arranged to a central transverse axis CT of the slide plate 32, the smaller is its extensions along its transverse axis. In other words, the length of the crack stopper apertures in Y-Axis direction decreases with its distance to the central transverse axis CT. Further, an interior end side of the crack stopper apertures 50 is provided with a through-hole 51 having an enlarged diameter compared to an adjacent section of the crack stopper aperture 50. By this configuration, a crack propagation can be avoided in a more efficient manner.

The first and the second slide elements 34, 36 are formed by a surface of the opposing edge regions 46, 48 of the slide plate 32. Further, a sliding surface of the first and the second slide elements 34, 36, that is a contact surface between the slide elements 34, 36 and the slide rails 38, 40, are covered with a self-lubricating coating. Specifically, the self-lubricating coating may contain Teflon. Accordingly, a sliding surface of the first and the second slide rails 38, 40, which are made of steel, may be coated with a DLC (Diamond Like Carbon) coating.

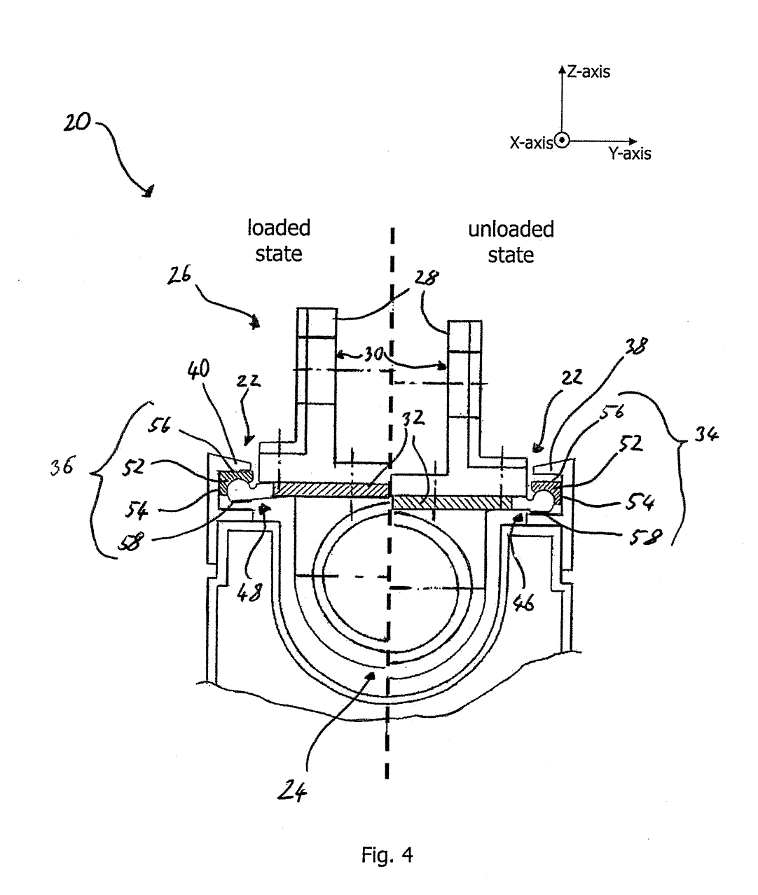

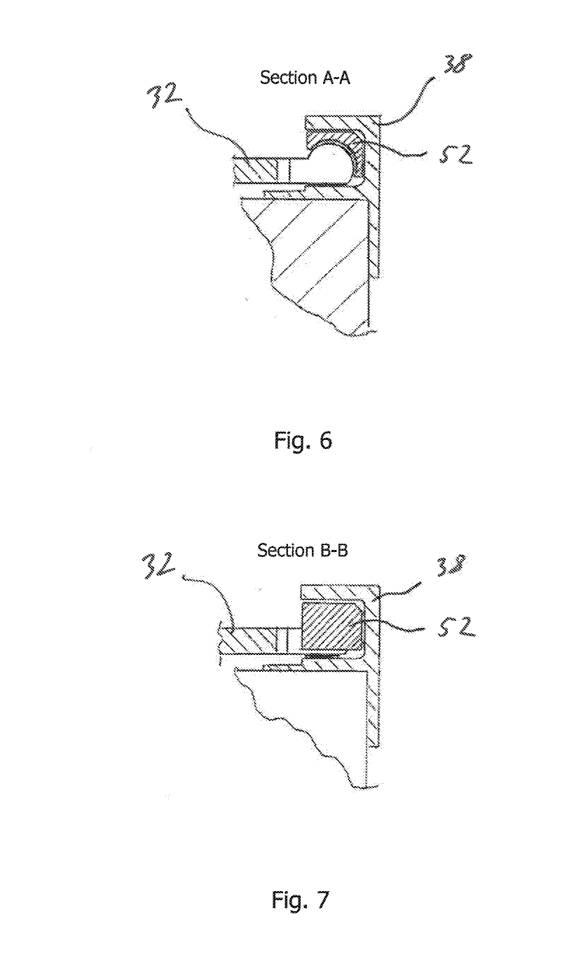

FIGS. 4 to 7 show a carriage 20 for supporting and guiding the aircraft flap according to a second embodiment. Compared to the carriage 20 shown in FIGS. 2 and 3, the first and the second slide elements 34, 36 are partially provided in form of attachments 52 detachably connected to the opposing edge regions 46, 48 of the slide plate 32.

FIG. 4 shows the carriage 20 which is engaged to the slide rails 38, 40 of the linear slide bearing 22 via the first and the second slide elements 34, 36 in two states. First, as can be gathered from the left side of FIG. 4, the carriage 20 is shown in a loaded state, i.e., during a flight operation of the aircraft. To that end, as can be gathered from the right side of FIG. 4, the carriage 20 is shown in an unloaded state, i.e., during a ground operation of the aircraft. In the loaded state, the attachments 52 are in contact with the slide rails 38, 40 with both a lateral surface 54 and an upper surface 56 of the attachments 52. In the unloaded state, the attachments 52 are in contact with the slide rails 38, 40 only with the lateral surface 54, wherein a bottom surface 58 of the edge regions 46, 48 of the slide plate 32 contacts the slide rails 46, 48, respectively. Thus, in the loaded state, the first and the second slide elements 34, 36 are formed by the attachments 52, i.e., the lateral surface 54 and the upper surface 56 thereof, and, in the unloaded state, the first and the second slide elements 34, 36 are formed partially by the attachments 52, i.e., the lateral surface 54 thereof, and partially by the edge regions 46, 48, i.e., the bottom surface 58, of the slide plate 32.

Further, the attachments 52 have an outer contour adapted to the shape of the slide rails 38, 40 and an inner contour adapted to an edge contour of the slide plate 32. Specifically, the edges of the slide plate 32 engaging with the attachments 52 have a rounded contour. Further, similar to the carriage 20 shown in FIGS. 2 and 3, also a sliding surface of the first and the second slide element 34, 36 are covered with a self-lubricating coating.

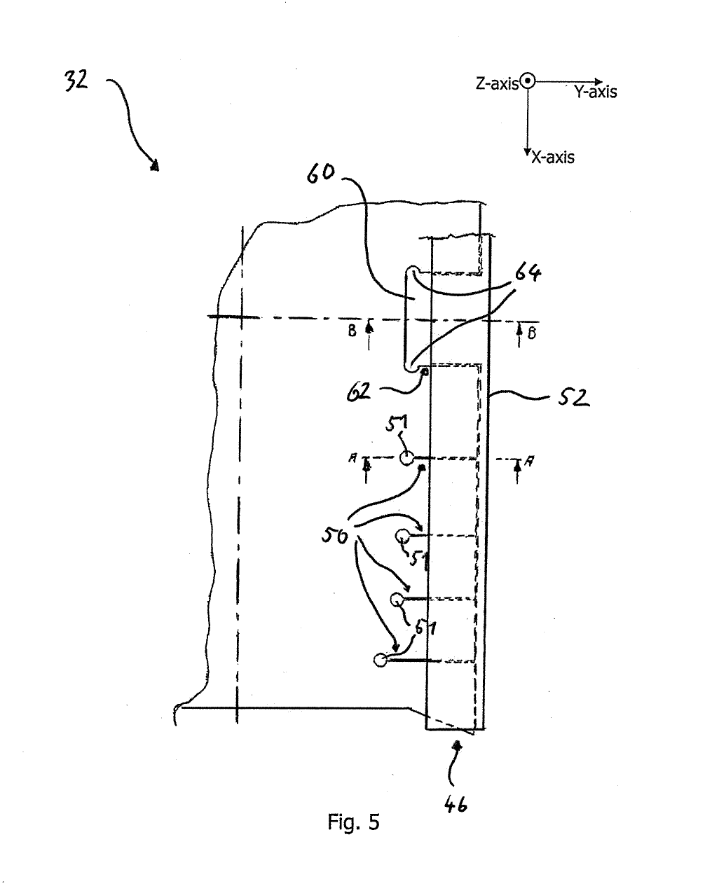

As can be gathered from FIGS. 5 to 7, the attachments 52 are provided with a first locking element 60 configured to engage with a complementary formed second locking element 62 provided by the slide plate 32. Specifically, the first locking element 60 is provided in form of a protrusion of the attachments 52 that, in a state interlocked with the slide plate 32, protrudes in direction of the central longitudinal axis CL of the slide plate 32 and, at its end portion, has bulges 64. Accordingly, the side plate 32 is provided with the second locking element 62 in form of a complementary recess for receiving the first locking element 60. By this configuration, the first and the second locking element 60, 62 are configured to lock a relative movement between the attachments 52 and the slide plate 32 in the movement direction of the carriage 20, i.e., along the X-axis. Further, i.e., by means of the bulges 64, also a relative movement between the attachments 52 and the slide plate 32 in a direction transverse to the movement direction, i.e., along the Y-axis, is locked.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A carriage for supporting and guiding an aircraft flap translationally moveable along a linear slide bearing, comprising:
a drive element configured to connect to an actuator for receiving a translational actuating force causing a translation of the carriage along the slide bearing;
a flap support configured to, upon translational movement of the carriage, transmit the actuating force to the flap; and
a slide plate with at least two slide elements arranged on opposed sides of the slide plate and engageable to at least two corresponding linear slide rails of the slide bearing.

2. The carriage according to claim 1, wherein the drive element is a screw nut which, together with a threaded shaft connectable to the screw nut, forms a linear actuator configured to translate rotational motion of the threaded shaft to linear motion of the carriage.

3. The carriage according to claim 2, wherein the linear actuator comprises a ball screw drive.

4. The carriage according to claim 2, wherein the linear actuator comprises a worm gear.

5. The carriage according to claim 1, wherein the flap support has a rotatory joint connectable to the flap.

6. The carriage according to claim 5, wherein the rotatory joint has a rotation axis transverse to a direction of movement of the carriage.

7. The carriage according to claim 5, wherein the flap support has a U-shaped cross section with two spaced connecting arms for receiving the rotary joint and a connecting element of the flap connectable to the rotary joint.

8. The carriage according to claim 7, wherein the flap support comprises a through-hole extending through the connecting arms for receiving the rotary joint.

9. The carriage according to claim 1, wherein the drive element and the flap support are mounted on opposite surfaces of the slide plate.

10. The carriage according to claim 1, wherein the slide elements extend along opposing edge regions of the slide plate.

11. The carriage according to claim 1, wherein the slide plate, in an area of each of the at least two slide elements, is provided with at least one crack stopper aperture which is provided in a thickness direction of the slide plate and extends from an edge of the slide plate in a direction of a central longitudinal axis of the slide plate beyond one of the slide elements.

12. The carriage according to claim 10, wherein the slide elements are formed by a surface of the opposing edge regions of the slide plate.

13. The carriage according to claim 10, wherein the slide elements are provided in form of attachments detachably connected to the edge regions of the slide plate, wherein the attachments have an outer contour adapted to a shape of the linear slide rails of the slide bearing and an inner contour adapted to an contour of the edge regions of the slide plate, and wherein the edge regions of the slide plate engaging with the attachments are at least partially rounded.

14. The carriage according to claim 13, wherein the attachments are provided with a first locking element configured to engage with a complementary formed second locking element provided by the slide plate and configured to lock a relative movement between the attachments and the slide plate in the translational movement direction of the carriage.

15. The carriage according to claim 14, wherein the second locking element further locks a relative movement between the attachments and the slide plate in a direction transverse to the movement direction.

16. The carriage according to claim 1, wherein a sliding surface of the slide elements is provided with a self-lubricating coating.

17. The carriage according to claim 16, wherein the self-lubricating coating contains polytetrafluorethylene.

18. An airfoil flap system for use in an aircraft, comprising:
a flap movable between an extended and retracted position;
a carriage configured to support and guide the flap according to claim 1 engaged with a linear slide bearing; and
an actuator connected to the carriage configured to generate an actuating force causing a translation of the carriage along the linear slide bearing to move the flap between its extended and retracted position.
